(19) United States
(12) Patent Application Publication
(10) Pub. No.: US 2008/0298598 A1
(43) Pub. Date: Dec. 4, 2008

(54) MUSIC DETECTING APPARATUS AND MUSIC DETECTING METHOD

(75) Inventor: Yuji Takao, Tokyo (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/051,459

(22) Filed: Mar. 19, 2008

(30) Foreign Application Priority Data
May 30, 2007 (JP) 2007143671

(51) Int. Cl. H04R 29/00

(52) U.S. Cl. 381/56

(57) ABSTRACT

According to one embodiment, there is provided a music detecting apparatus including; a first detecting unit configured to detect, based on a sound volume ratio of two channels included in the information, a music section included in an information; a second detecting unit configured to detect a commercial message section included in the information; and a processing unit configured to process, based on a ration of an overlapping section between the music section and the commercial message section to the music section, the music section as a non-music section, if the music section at least partly overlaps with the commercial message section.

### CROSS-REFERENCE TO RELATED APPLICATIONS

This application is based upon and claims the benefit of priority from Japanese Patent Application No. 2007-143671, filed on May 30, 2007, the entire contents of which are incorporated herein by reference.

### BACKGROUND

1. Field

One embodiment of the invention relates to detect, for instance, music information included in picture/sound signals.

2. Description of the Related Art

Picture/sound recording apparatuses which mount thereon hard disks having large storage capacities, and the like have been popularized. Data sizes of image recording information have been increased. Function capable of retrieving target information (for example, music information portions) included the image recording information in higher efficiencies may be implemented.

It is disclosed by, for example JP-A-2006-301134, that detecting a music portion has been proposed. While a total value of electric power of each channel of two channel sounds is calculated, differences between the electric power of each channel of the two channel sounds are calculated, a ratio of these calculated power values is calculated, and the calculated ratio of the power values is compared with a threshold value, so that a music section is judged based upon the comparison result.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram for schematically showing an arrangement of a music detecting apparatus according to an embodiment of the invention;

FIG. 2 is an exemplary flow chart for representing an example of a music section detection according to the embodiment;

FIG. 3 is an exemplary diagram for showing an example of a sound volume ratio calculation section according to the embodiment;

FIG. 4 is an exemplary status transition diagram for representing an example of a music section detection by a status transition machine of a music section detecting unit 4 according to the embodiment;

FIG. 5 is a diagram for showing another example of a sound volume ratio calculation section according to the embodiment;

FIG. 6 is an exemplary diagram for indicating a calculation example of totalizing sound volumes according to the embodiment;

FIG. 7 is an exemplary diagram for indicating a detection example of a CM section and a music section according to the embodiment; and

FIG. 8 is an exemplary diagram for indicating a detection example of a CM section and a music section according to the embodiment.

### DETAILED DESCRIPTION

Various embodiments will be described hereinafter with reference to the accompanying drawings. In general, according to one embodiment of the invention, there is provided a music detecting apparatus including: a first detecting unit configured to detect, based on a sound volume ratio of two channels included in the information, a music section included in an information; a second detecting unit configured to detect a commercial message section included in the information; and a processing unit configured to process, based on a ration of an overlapping section between the music section and the commercial message section to the music section, the music section as a non-music section, if the music section at least partly overlaps with the commercial message section.

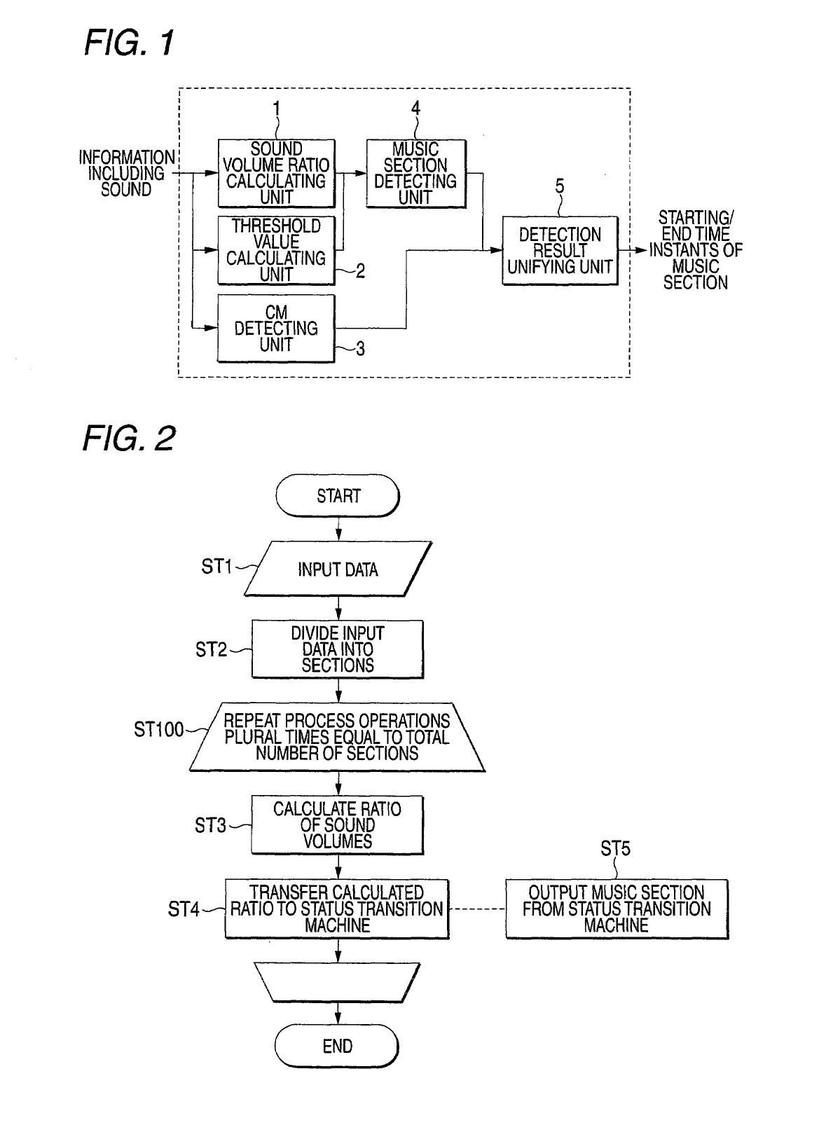

According to an embodiment, FIG. 1 shows a block diagram for schematically showing an arrangement of a music detecting apparatus according to the embodiment.

The music detecting apparatus processes information (audio information) including at least sounds, for example, a music program. The music detecting apparatus has been equipped with a sound volume ratio calculating unit 1, a threshold value calculating unit 2, a CM detecting unit 3, a music section detecting unit 4, and a detection result unifying unit 5.

The sound volume ratio comparing calculating unit 1 subdivides entered processing subject information (for instance, MPEG file) into predetermined sections (in unit of predetermined time), and calculates a sound volume difference of right and left channels (namely, two channels) and a total sound volume of the right and left channels, and furthermore, calculates a ratio of the above-explained sound volume difference to the above-described total sound volume (namely, sound volume ratio).

The threshold value calculating unit 2 holds thereinto both a threshold value “A” and a threshold value “C” with respect to the sound volume ratio, and holds thereinto both a threshold value “B” and a threshold value “D” with respect to output times of the right and left channels. Also, the threshold value calculating unit 2 calculates the threshold value “A” and the threshold value “C” in a dynamic manner based upon a feature of entered processing subject information. For example, there is a difference between averaged values of sound volumes with respect to a ground-based digital broadcasting system and a ground-based analog broadcasting system. In other words, if the same threshold value is employed in both the ground-based digital broadcasting system and the ground-based analog broadcasting system, then there is a risk that proper threshold judging operation cannot be carried out. As a consequence, the threshold value calculating unit 2 determines the threshold value “A” and the threshold value “C” in the dynamic manner based upon an averaged value of sound volumes of audio information included in the entered processing subject information.

The music section detecting unit 4 detects a music section included in processing subject information based upon a sound volume ratio of right and left channels of audio information included in the processing subject information. For example, the music section detecting unit 4 calculates a sound volume difference of the right and left channels, and also, a total sound volume of the right and left channels in the unit of a predetermined time; calculates such a sound volume ratio indicative of a ratio of the sound volume to the total sound volume; and then, calculates such a section as the music section, in which this calculated sound volume ratio is larger than the threshold value “A” and a time during which the sound volume ratio exceeds this threshold value “A” is longer than the threshold value “B.”

The CM detecting unit 3 detects a CM (Commercial Message) from a feature of a picture and a feature of a sound in the case that entered processing subject information is a broadcast picture. For example, the CM detecting unit 3 detects at least two pieces of silent sections (no sound sections) having smaller sound volumes than a predetermined sound volume, which are included in the processing subject information, and then, detects a CM section which is sandwiched between the detected silent sections.

The detection result unifying unit 5 compares a position of a detected music section with a position of a detected CM section so as to process the music section as a non-music section based upon a ratio of the music section to an overlap section where the CM section overlaps with the music section under such a condition that at least a portion of the music section is included in the CM section. The detection result unifying unit 5 finally outputs both a starting time instant and an end time instant of the music section.

Now, a description is made of a detecting operation for detecting a music section from inputted processing subject information. FIG. 2 is a flow chart for describing an example as to the music section detecting operation.

The sound volume ratio calculating unit 1 inputs thereinto sound information made of a plurality of channels (step ST1), and then, subdivides this input sound information into sections segmented in the unit of a predetermined time (step ST2). Subsequently, process operations from a step ST3 to a step ST5 are repeatedly performed plural times equal to a total number of these divided sections.

The sound volume ratio calculating unit 1 calculates a sound volume ratio of each of these subdivided sections (step ST4). In order words, the sound volume ratio calculating unit 1 calculates a sound volume difference of right and left channels (two channels) and also a total sound volume of the right and left channels (two channels) with respect to a first section, and furthermore, calculates a ratio of this sound volume difference to the above-described total sound volume (sound volume ratio) (step ST3). The sound volume ratio calculating unit 1 notifies the calculated sound volume ratio to a status transition machine of the music section detecting unit 4. Subsequently, similar to the above-described calculating manner, the sound volume ratio calculating unit 1 calculates a sound volume difference of right and left channels (two channels) and also a total sound volume of the right and left channels (two channels) with respect to a second section subsequent to a first section, and furthermore, calculates a ratio of this sound volume difference to the above-described total sound volume (sound volume ratio). The sound volume ratio calculating unit 1 notifies the calculated sound volume ratio to the status transition machine of the music section detecting unit 4. Subsequently, the process operations are repeatedly performed plural times equal to a total number of these divided sections.

The status transition machine of the music section detecting unit 4 detects such a section as a music section, in which a sound volume ratio is larger than the threshold value “A”, and further, a time during which the sound volume ration exceeds the threshold value A becomes longer than the threshold value “B” (step ST5).

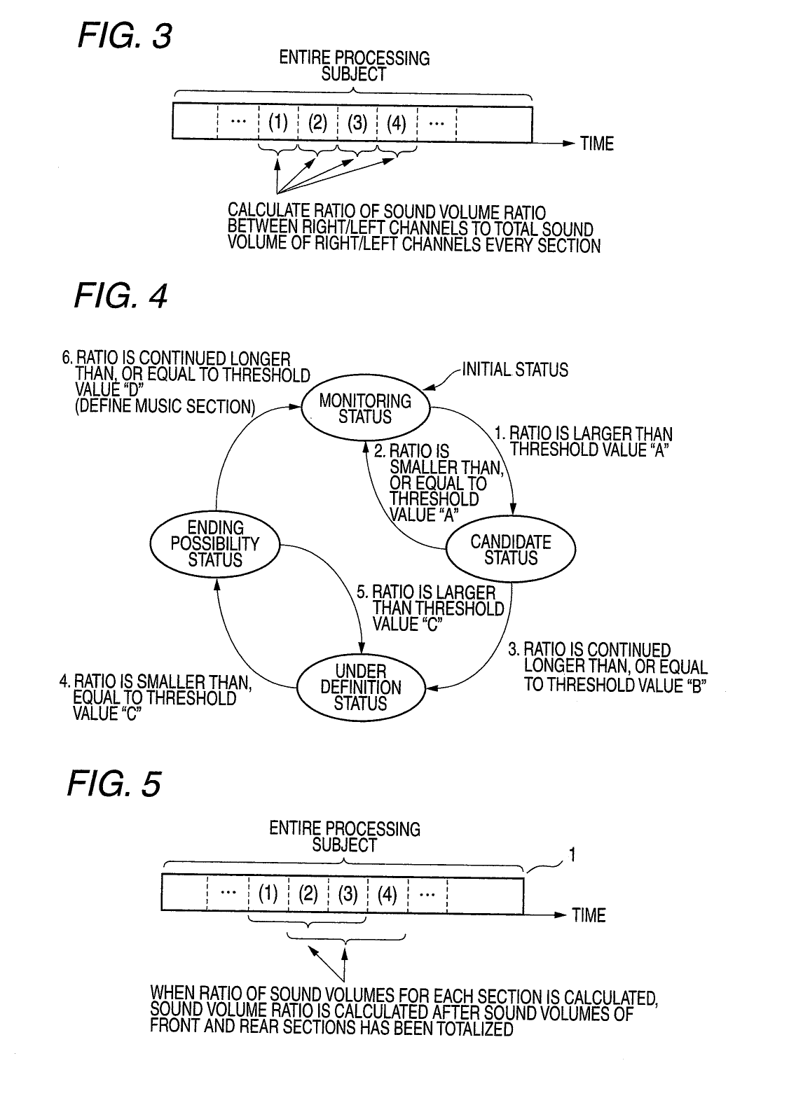

FIG. 3 is a diagram for representing an example as to a sound volume ratio calculation section.

As indicated in FIG. 3, an entire portion of processing subject information is subdivided into a plurality of sections in the unit of a predetermined time. For instance, the entire processing subject information is subdivided into such a plurality of sections which contain a first section (1) a second section (2), a third section (3), and a fourth section (4). It should be understood that information which appears later under temporal condition is located on a right side. That is to say, information included in the second section (2) rather than the first section (1) is such an information which appears later under the temporal condition. Similarly, information included in the third section (3) rather than the second section (2) is such an information which appears later under the temporal condition. Also, information included in the fourth section (4) rather than the third section (3) is such an information which appears later under the temporal condition. The sound volume ratio calculating unit 1 calculates a sound volume ratio as to each of these sections.

FIG. 4 is a status transition diagram for showing an example of the music section detection by the status transition machine of the music section detecting unit 4.

The status transition machine of the music section detecting unit 4 detects a music section based upon a sound volume ratio of each of these sections. The status transition machine holds both the threshold value “A” and the threshold value “B” related to the sound volume ration, and holds both the threshold value “B” and the threshold value “D” related to the time length. When a first condition can be satisfied under which a sound volume ratio is larger than the threshold value “A” and a time during which the sound volume ratio exceeds the threshold value “A” is continued longer than, or equal to the threshold value “B (seconds)”, this status transition machine detects such a time instant which newly exceeds the threshold value “A” as a starting time instant of a music section. Next, under the condition that the first condition has been satisfied, when such a second condition that a sound volume ratio is smaller than the threshold value “C” and a time during which the sound volume ratio becomes shorter than the threshold value “C” is continued longer than the threshold value “D (seconds)”, the status transition machine detects such a time instant which newly becomes shorter than the threshold value “C” as an end time instant of the music section.

In addition, the status transition machine will now be described in detail. The below-mentioned 4 pieces of statuses are present in the status transition mechanism.

monitoring status (initial condition)

candidate status

under definition status

ending possibility status

It should be understood that the monitoring status is an initial condition.

Moreover, the below-mentioned 6 sorts of transitions are determined.

1. In the case that a sound volume ratio inputted under monitoring status is larger than the threshold value “A”, the monitoring status is moved to the candidate status. A transition time instant (namely, information for exclusively specifying position under analysis) at this time is assumed as “T1.”

2. In the case that a sound volume ratio inputted under candidate status is smaller than, or equal to the threshold value “A”, the candidate status is moved to the monitoring status.

3. In such a case that a time during which a sound volume ratio entered under candidate status is larger than the threshold value “A” is continued longer than, or equal to “B” seconds, the candidate status is moved to the under definition status.

4. In the case that a sound volume ratio entered under the definition status is smaller than, or equal to the threshold value “C”, the under definition status is moved to the end possibility status. At this time, the transition time instant is assumed as “T2.”

5. In such a case that a ratio inputted under the end possibility status is larger than the threshold value “C”, the end possibility status is moved to the under definition status.

6. In such a case that a time during which a ratio inputted under the end possibility status is smaller than, or equal to the threshold value “C” is continued longer than, or equal to “D” seconds, the end possibility status is moved to the monitoring status. A music section is defined based upon this transition. In other words, the status transition machine defines the time duration from “T1” to “T2” as the music section.

Alternatively, while an allowable range may be provided in a transition condition, when the transition condition may be satisfied plural times larger than, or equal to “n” times, the present transition status is newly moved. As a result, even when the processing subject information is unstable, the music section may be detected in high reliability.

Also, the threshold values “A” and “C” may not be selected to be fixed values, but may be alternatively selected to such values which are dynamically calculated based upon the inputted processing subject information. For example, the threshold value calculating unit 2 may calculate the threshold values “A” and “C” based upon an averaged value of sound volumes of the entered processing subject information. As a result, in such a case that a music section detecting operation from the same processing subject information is carried out by plural sets of music detecting apparatuses, even when sound volumes of the processing subject information entered to the respective music detecting apparatuses are different from each other, the same music section detection results may be obtained.

Also, in order to more correctly acquire a music section, such a transforming function may be alternatively applied, for instance, adding/subtracting/multiplying/dividing process operations of a constant may be given to a sound volume ratio, or a sound volume ratio may be raised to the nth power. Alternatively, the transforming function may be applied only in such a case that any one of the sound volume difference between the right and left channels, the total sound volume of the right and left channels, and the ratio of the sound volume difference to the total sound volume may satisfy a predetermined condition.

FIG. 5 is a diagram for showing another example of a sound volume ratio calculation section. Although the sound volume ratio calculation section has been explained with reference to FIG. 3, such a sound volume ratio calculation section indicated in FIG. 5 may be alternatively employed. In other words, the sound volume ratio may be calculated in the unit of a predetermined time where the times temporarily overlap with each other.

As indicated in FIG. 5, an entire portion of processing subject information is subdivided into a plurality of sections in the unit of a predetermined time. For instance, the entire processing subject information is subdivided into such a plurality of sections which contain a first section (1) a second section (2), a third section (3), and a fourth section (4). It should be understood that information which appears later under temporal condition is located on a right side. That is to say, information included in the second section (2) rather than the first section (1) is such an information which appears later under the temporal condition. Similarly, information included in the third section (3) rather than the second section (2) is such an information which appears later under the temporal condition. Also, information included in the fourth section (4) rather than the third section (3) is such an information which appears later under the temporal condition.

Assuming now that the first section (1), the second section (2), and the third section (3) are defined as a section “A”, whereas the second section (2), the third section (3), and the fourth section (4) are defined as a section “B”, the sound volume ratio calculating unit 1 calculates a sound volume “A1” and a total sound volume “A2” of the section “A”, and further, calculates a sound volume difference “B1” and a total sound volume “B2” of the section “B.” The sound volume ratio calculating unit 1 calculates a ratio of the sound volume difference A1 to the total sound volume A2, and then defines the calculation result as a sound volume ratio of the second section (2). Similarly, the sound volume ratio calculating unit 1 calculates a ratio of the sound volume difference B1 to the total sound volume B2, and then defines the calculation result as a sound volume ratio of the second section (3). In other words, the sound volume ratio calculating unit 1 calculates the total sound volumes in the unit of a predetermined time which partially overlaps with each other.

As a result, in the case that music sections are detected by the same processing subject information by a plurality of music detecting apparatuses, even when time counts by timers built in the respective music detecting apparatuses are shifted from each other, namely even when analysis starting positions are different from each other and detection subjects are shifted, the same music section detecting result can be obtained.

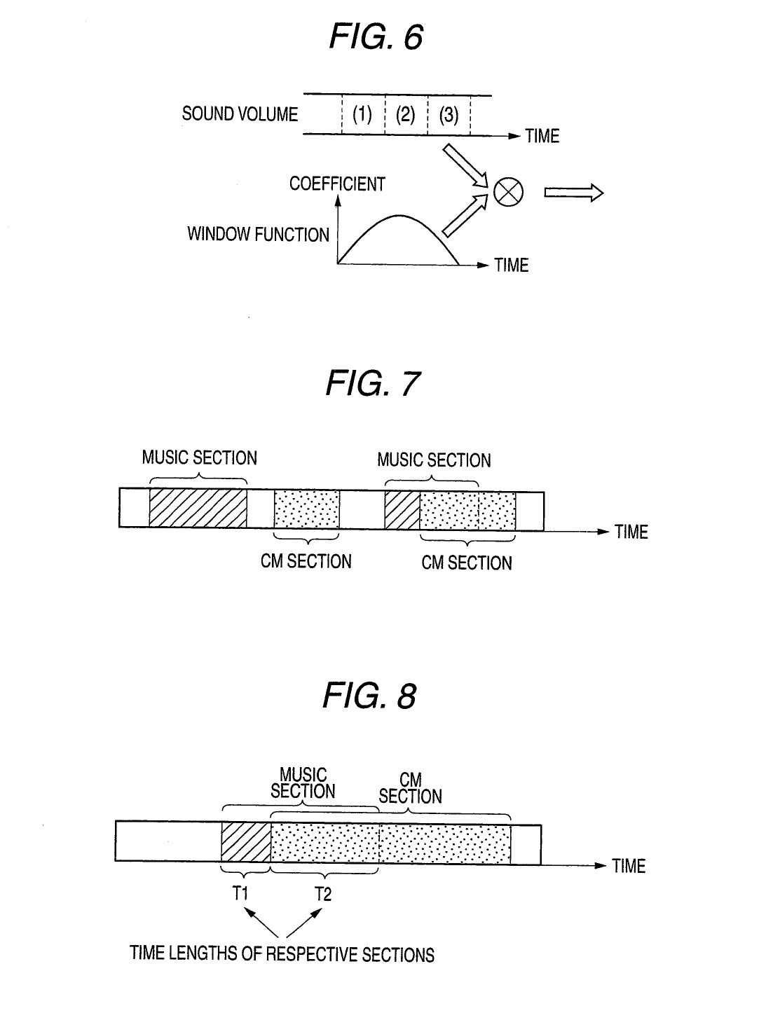

As indicated in FIG. 6, when sound volumes are totalized, since a window function is applied, a total sound volume may be alternatively calculated by increasing a sound volume of a section which is sandwiched by a front section and a rear section rather than sound volumes of the front section and the rear section. For instance, when a sound volume ratio of the second section (2) is calculated, a sound volume of the second section (2) is increased rather than sound volumes of the first section (1) and the third section (3). In other words, a total sound volume “A” of the section “A” is calculated.

(first section/n+second section+third section/n)*m(symbols “n” and “m” being constants) (formula 1).

Subsequently, a description is made of a CM detection. There are portions (no sound sections) having low sound levels before and after 1 piece of CM (commercial message), and there is a regularity in lengths of CMs. The CM detecting unit 3 detects at least two pieces of no sound sections having sound volumes smaller than a predetermined sound volume, which is included in processing subject information. Furthermore, the CM detecting unit 3 detects such a section as a CM section, which corresponds to a section sandwiched by two pieces of the detected no sound sections, and is coincident with the regularity as to the lengths of CMs. Alternatively, the CM detecting unit 3 may detect a CM section based upon a detection of picture switching (changing amount of pictures) which are included in channel information of a sound, and processing subject information.

Next, a detailed description is made of one example as to CM detections. The CM detecting unit 3 detects a no sound portion having a sound volume smaller than a predetermined sound volume, which is included in processing subject information. At this time, the CM detecting unit 3 stores thereinto information about the no sound portion (namely, information of time instant when no sound portion is judged). In addition, the CM detecting unit 3 judges whether or not a time interval between he detected no sound portion and the next no sound portion is equal to a multiple of a constant time. For instance, there are many opportunities that CMs are broadcasted every multiple of 15 seconds. That is to say, the CM detecting unit 3 may judge whether or not a section between a no sound portion and a next no sound portion corresponds to a CM by checking whether or not a time interval between the above-described no sound portion and the next sound portion is equal to the multiple of 15 seconds. Then, if the time interval is equal to the multiple of the constant time, then the CM detecting unit 3 counts the no sound portions, and then, if a counted value of these no sound portions is larger than, or equal to a threshold value, then the CM detecting unit 3 detects such a section as a CM section, while this section is sandwiched between the firstly appearing no sound portion and the finally appearing no sound portion. For instance, the firstly appearing no sound portion corresponds to a CM starting time instant, whereas the finally appearing no sound portion corresponds to a CM end time instant.

It is so assumed that, for example, there were two times of commercial time periods within a single program (for instance, program whose recording was reserved). It is also assumed that 4 pieces of commercial messages made of CM1, CM2, CM3, CM4 were broadcasted during the first commercial time period, whereas 3 pieces of commercial messages made of CM5, CM6, CM7 were broadcasted during the second commercial time period.

For instance, in the first commercial time period, the no sound portion 1→CM1→no sound portion 2→CM2→no sound portion 3→CM3→no sound portion 4→CM4→no sound portion 5 are sequentially detected. As a result, such a section sandwiched between the firstly appearing no sound portion 1 and the finally appearing no sound portion 5 is detected as the CM section. For instance, the firstly appearing no sound portion 1 corresponds to the CM starting time instant, whereas the finally appearing no sound portion 5 corresponds to the CM end time instant.

Similarly, in the second commercial time period, the no sound portion 6→CM5→no sound portion 7→CM6→no sound portion 8→CM7→no sound portion 9 are sequentially detected. As a result, such a section sandwiched between the firstly appearing no sound portion 6 and the finally appearing no sound portion 9 is detected as the CM section. For instance, the firstly appearing no sound portion 6 corresponds to the CM starting time instant, whereas the finally appearing no sound portion 9 corresponds to the CM end time instant.

FIG. 7 is a diagram for indicating a detection example as to a CM section and a music section. There are the below-mentioned three cases, namely, as indicated in a left portion of FIG. 7, the CM section and the music section are independently detected; as represented in a right portion of FIG. 7, the CM section partially overlaps with the music section; and furthermore, one section (music section) is included in the other section (CM section).

There is such a need that a music section (singing scene) included in an originally edited program which is included in processing subject information is correctly extracted so as to be recorded in a saving-purpose medium. To this end, both a starting position and an end position of the music section must be correctly detected. However, since there are some possibilities that music is applied to CMs, the following erroneous detections may be conceived. That is, a CM section may be erroneously detected as the music section, or a partial section included in the CM section may be erroneously detected as the music section. Also, there are many cases that CM sections contain music. Also, a large number of such elements are present in originally edited programs located near CMs, while these elements may be easily detected as music, and these detectable elements are, for instance, showy effect sounds, hand clapping, and the like. In order to satisfy the above-described condition, the originally edited program located near the CM should not be erroneously detected as the music section. Accordingly, the detection result unifying unit 5 correctly separates a CM section from a music section. A detailed description of this section separating operation by the detection result unifying unit 5 will now be made as follows:

As indicated in FIG. 8, when a detection is made that a CM section partially overlaps with a music section, a time length of such a portion of the music section, which does not overlap with the CM section, is set as “T1”, whereas a time length of such a portion of the music section, which overlaps with the CM section, is set as “T2.”

A ratio of a length of the music section to a length of the CM section present in the music section is calculated in accordance with the below-mentioned formula (2).

T2/(T1+T2) (formula 2).

The detection result unifying unit 5 compares the above-described ratio with a threshold value, and if the ratio is larger than the threshold value, then the detection result unifying unit 5 judges that the music section included in the CM section, and the originally edited program near the CM are detected. In other words, in such a case that the above-explained ratio is larger than the threshold value, the detection result unifying unit 5 judges that the detected music section is erroneously detected, and processes the detected music section as the non-music section.

Also, since a music section has a certain length, such a condition that “T1 is smaller than threshold value” may be alternatively added as the condition for processing the detected music section as the non-music section. Since this condition is additionally provided, the originally edited program located near the CM may be more correctly judged as either the music section or the non-music section.

The below-mentioned effects can be obtained in accordance with the above-described embodiment mode.

(1) If a music section is tried to be detected only based upon a sound volume difference of right and left channels, then there is a risk that either a CM section or an originally edited program located near a CM may be erroneously detected as the music section. In the present embodiment mode, since the CM detection result is utilized, the music section can be detected in higher precision.

In the case that the same broadcasting program is processed by a plurality of music detecting apparatuses different from each other, there are some possibilities that the same music section detection result cannot be obtained due to temporal shifts of the broadcasting program and sound volume differences of the broadcasting program. In accordance with the music detecting apparatus of the present embodiment mode, when the same broadcasting program is processed by plural sets of these music detecting apparatuses, the same music section detection results can be obtained.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A music detecting apparatus, comprising:
a first detecting unit configured to detect a music section included in information based on a sound volume ratio of two channels included in the information;
a second detecting unit configured to detect a commercial message section included in the information; and
a processing unit configured to process, based on a ratio of the length of an overlapping section between the music section and the commercial message section to the length of the music section, the music section as a non-music section, if the music section at least partially overlaps with the commercial message section.

2. The music detecting apparatus of claim 1, wherein the first detecting unit is configured to calculate a sound volume difference of the two channels and a total sound volume of the two channels in a predetermined period of time,
wherein the first detecting unit is configured to calculate a sound volume ratio comprising a ratio of the sound volume difference to the total sound volume, and
wherein, if the sound volume ratio is larger than a first threshold value in a section, and a time during which the sound volume ratio exceeds the first threshold value is longer than a second threshold value in the section, the first detecting unit is configured to detect the section as the music section.

3. The music detecting apparatus of claim 1, wherein the first detecting unit is configured to determine the first threshold value based on an average value of sound volume of the information.

4. The music detecting apparatus of claim 2, wherein the first detecting unit is configured to calculate the sound volume ratio using sound volume difference data and total sound volume data from overlapping periods of time.

5. A music detecting method, comprising:
Detecting a music section included in information based on a sound volume ratio of two channels included in the information;
detecting a commercial message section included in the information; and
processing, based on a ratio of the length of an overlapping section between the music section and the commercial message section to the length of the music section, the music section as a non-music section, if the music section at least partially overlaps with the commercial message section.

6. The music detecting method of claim 5, comprising:
calculating a sound volume difference of the two channels and a total sound volume of the two channels in a predetermined period of time;
calculating a sound volume ratio comprising a ratio of the sound volume difference to the total sound volume; and
detecting a section as the music section if the sound volume ratio is larger than a first threshold value in the section and a time during which the sound volume ratio exceeds a first threshold value is longer than a second threshold value in the section.

7. The music detecting method of claim 5, further comprising determining the first threshold value based on an average value of sound volume of the information.

8. The music detecting apparatus of claim 6, further comprising calculating the sound volume ratio using sound volume difference data and total sound volume data from overlapping periods of time.
